(19) United States
(12) Patent Application Publication
(10) Pub. No.: US 2011/0284251 A1
(43) Pub. Date: Nov. 24, 2011

(54) FIRE EXTINGUISHING DEVICE AND FIRE MANAGEMENT SYSTEM

(75) Inventors: Johannes Diedericus Jacobus Couvee, LR Delft (NL); Abraham Gijsbertus Leendert Van Der Ende, Amsterdam (NL)

(73) Assignees: Abraham Gijsbertus Leendert VAN DER ENDE, JS Amsterdam (NL); Dingeman DE JONG, HN Ede (NL); OCTAAF ADVIESGROEP B.V., AH Nieuwegein (NL); DSPA.NL B.V., AN Nijmegen (NL); Franciscus Hubertus Josef VOGELZANGS, CJ Beuningen (NL)

(21) Appl. No.: 13/060,967

(22) PCT Filed: Aug. 25, 2009
(86) PCT No.: PCT/NL09/50512

§ 371 Date: Aug. 16, 2011

(30) Foreign Application Priority Data
Aug. 25, 2008 (NL) 2001917

(51) Int. Cl. A62C 13/66

(52) U.S. Cl. 169/71

(57) ABSTRACT

The invention relates to a device for extinguishing a fire which is suitable for carrying and handling by persons. The device includes a pressureless container for placing an extinguishing agent in solid form, an ignition member to ignite the extinguishing agent forming aerosol during extinguishing operations, a discharge member for discharge of the aerosol in a directed jet or plume, a handling member for handling of the device by a user, and a communication member for remote communication.

The present invention relates to a fire extinguishing device, a fire extinguishing cartridge and a fire management system comprising such a fire extinguishing device.

When a fire breaks out it is important to extinguish the fire as quickly as possible. Many valuable minutes have usually already passed before the fire brigade arrives. Fire extinguishing appliances are therefore present in many buildings in order to be able to extinguish a fire immediately. A known example hereof is the rolled-up fire hose connected via a tap to the water main. A second known example are the sprinkler installations which are also connected to the water main. Water is in many cases a good extinguisher. There are however situations in which water as extinguisher has little effect, or where water even has an adverse effect, such as when the water begins to react with chemicals that are present. Water damage also occurs, this being highly undesirable.

Alternatives have been devised to obviate these drawbacks. A first alternative are extinguishing gas installations, which are particularly effective for extinguishing fires in spaces where the extinguishing agent may not be electrically conductive. In addition, there are water mist appliances which are applied in the case of fires with great generation of heat. Thirdly, extinguishing powder installations are used, these being installed mainly in industrial environments in order to extinguish flammable gases and highly inflammable chemicals. A further alternative are the foam extinguishing installations, wherein the surface which is on fire is covered by means of a foam layer. The foam is stored under pressure in a pressure vessel. Another alternative are extinguishers which make use of carbon dioxide (CO₂). These extinguishers have a hose and a black expansion horn or snow horn at the outer end of the hose. Between expansion horn and hose is a handle which must be held during use of the extinguisher. The handle is necessary because the outer end of the unprotected horn becomes very cold (up to about −80° C.), and this extreme cold can cause third-degree burns.

Reference is further made to so-called halon extinguishers. Due to possible environmental damage the use and possession of halons in fire extinguishers and fire safety systems has been banned in the Netherlands and Belgium since 1 Jan. 2004. An exception is made for critical applications in civil aviation and in the military field. Halon extinguishers were mainly utilized in computer areas because the halon did not damage electronic equipment. Halons are halogenated hydrocarbons. Under pressure they are compressed into a liquid. The extinguishing action is realized by the negative catalytic effect on the combustion process.

A recent development are aerosol extinguishers. An aerosol is a colloidal mixture of a substance in a gas. Colloidal is the state of substances present in finely distributed manner in a liquid or gas, wherein the particles are larger than a molecule and smaller than the particles in suspension. In this state aerosol is a dry, suspended substance which behaves in the first instance as a turbulent white smoke. This substance remains in suspension as long as there are great temperature differences within a space. The extinguishing mechanism is as follows; after activation of the dry, solid extinguishing agent it is discharged as dry aerosol. The dry aerosol extinguishes chemically, by intervening in the chain reaction of the combustion process by binding the free radicals. Binding the free radicals prevents the free electrons in the outer surface layer of the substance being able to react with other substances, thereby stopping the combustion process. Both actions take place mainly on the surface of the micro-size particles in the dry aerosol. The smaller the particles, the more effective the action of the mechanism. Aerosol extinguishers consist of pressureless containers containing an extinguishing agent in solid form. This substance combusts after electrical or thermal ignition. Microscopically fine extinguishing powder is herein discharged at high speed in the form of a mist. This mist spreads like a gas and is a highly effective extinguishing agent. The field of application of these extinguishers has heretofore remained limited however to the smaller enclosed spaces in order to achieve the desired concentration.

The present invention has for its object to provide a fire extinguisher which can be easily handled by a user in order to extinguish a fire at a random location.

This object is achieved with a device for extinguishing a fire which is suitable for carrying and handling by persons, comprising:
a pressureless container for placing of an extinguishing agent in solid form;
an ignition member for electrical or thermal ignition of the extinguishing agent for the purpose of forming aerosol during extinguishing operations;
a discharge member for discharge of the aerosol in a directed jet or plume;
a handling member for handling of the device by a user; and
a communication member for remote communication.

By means of the communication means it is possible for a user of the portable device to have contact with persons who can provide or call in assistance and further extinguishing. Advice can also be sought, and a warning can be provided for the surrounding area. Physically disabled persons in particular can benefit from such a device because the application of aerosol-based extinguishing is available with a relatively low weight compared to longer known portable extinguishing devices. By means of the invention it becomes possible for instance to provide a device with a spraying duration of about 30-90 seconds and a weight of about 50-500 grams of active extinguishing material without a pressure vessel being necessary as in known fire extinguishers. In its entirety such a fire extinguisher can have a weight of less than a kilogram.

Through the use of an aerosol as extinguishing agent and a suitable discharge member it is further possible to create a directed jet/plume. At a distance of at least two to for instance six metres from the source of the fire, this plume makes it possible to still be able to reach the source in directed manner with a manually operated fire extinguisher. This is relatively far compared to foam and powder extinguishers. Owing to the use of aerosol no pressure vessel need be applied as in the case of powder and foam extinguishers. The device is hereby relatively light in weight. One of the resulting options is that the whole extinguisher can be carried and operated with one hand. This makes the extinguisher highly suitable for use by disabled persons who are for instance in a wheelchair.

In a first preferred embodiment the device comprises location-determining means for determining the geographic location of the device in automated manner. This information can hereby be transmitted by means of the communication means to emergency services or third parties who can make further contact or take action. Variants of location-determining means provided for embodiments include GPS, AGPS and/or location-determining means based on mobile telephony standards.

In further preferred embodiments the communication means comprise voice communication means. Humanly discernible information relating to the situation can hereby be transmitted. It is hereby also possible to communicate advice orally to people in the fire situation.

The device is more preferably adapted to send a message to a fire management system as soon as the ignition member is activated. The stated advantages are hereby also achieved if the person in the fire situation does not realize at that moment that communication is possible and would therefore not use it or would forget it.

In an embodiment the communication member is adapted for two-way communication. This makes it possible for control room staff to communicate with the user. Staff can hereby obtain information via the user on the spot. In this case staff can also give the user instructions.

In order to keep the device in operating mode a connector is preferably provided for placing in a docking station for the purpose of charging a battery in the device. The device can hereby always be available on standby at its storage position without the eventual user having to take action for this purpose.

It is also possible for the device to be provided with a battery which preferably has a minimum lifespan of 5-10 years. The device is optionally provided with a provision which gives an alarm signal when the battery is almost empty.

The device preferably comprises potassium carbonate, ammonium hydrogen carbonate and/or potassium nitrate as extinguishing agent. Such extinguishing agents extinguish effectively and are for instance not harmful to humans.

In a further embodiment the device comprises a protective casing (2), a part of which functions as discharge member and in which the pressureless container is arranged, optionally in removable manner. The advantages of such an arrangement are a simple and functional design.

The housing functions partly as barrel, thereby saving on parts.

A protective casing which comprises a plastic also provides the advantage that it will be light in weight.

With an activating switch for the device which is arranged in or on the handle and which, at least during use, can be electronically connected to the ignition member, the ignition member can be activated by switching the activating switch. It is advantageous here that the activation can either be effected automatically or by means of a hand movement which is natural while the handle is being held.

The pressureless container more preferably comprises a cartridge holder adapted for the placing of one or more extinguishing agent cartridges, wherein the number lies between 1-6 and preferably equals 3.

The device more preferably comprises a chamber for receiving aerosol from the pressureless container, wherein the chamber comprises a plurality of openings in an outlet wall for passage of the aerosol.

The handle more preferably extends in a direction substantially perpendicularly of a main axis of the discharge member. This can hereby be handled in simple manner as a pistol.

A further aspect of the invention relates to a device for extinguishing a fire which is suitable for carrying and handling by persons, comprising:
a pressureless container for placing of an extinguishing agent in solid form;
an ignition member for electrical or thermal ignition of the extinguishing agent for the purpose of forming aerosol during extinguishing operations;
a discharge member for discharge of the aerosol in a directed jet or plume;
a handling member for handling of the device by a user; and
an arm support member for supporting the arm during an extinguishing operation, wherein the arm support member extends substantially in line with the direction in which the extinguishing agent is discharged. An advantage of such a device is that it is easy to handle, even by people with relatively little arm strength. The natural method of determining the direction by means of the arm support member makes this embodiment very safe in use, and effective.

A further aspect of the present invention relates to a cartridge for a device according to the present invention, wherein the cartridge comprises an extinguishing agent for forming aerosols.

The cartridge is preferably of cylindrical form, and is substantially enclosed by a packaging.

The cartridge more preferably comprises a through-hole.

The cartridge more preferably comprises a thermal activating module which is adapted to generate a predetermined temperature using an electric current and to thus activate the extinguishing agent.

A further aspect of the present invention relates to a fire management system for registering a fire, comprising:
a device according to the present invention;
a central communication unit for providing communication with the devices.

The fire management system preferably comprises a number of detectors adapted to detect fire and/or smoke.

Further advantages, features and details of the present invention will be further elucidated on the basis of a description of several embodiments, with reference to the accompanying figures, in which:

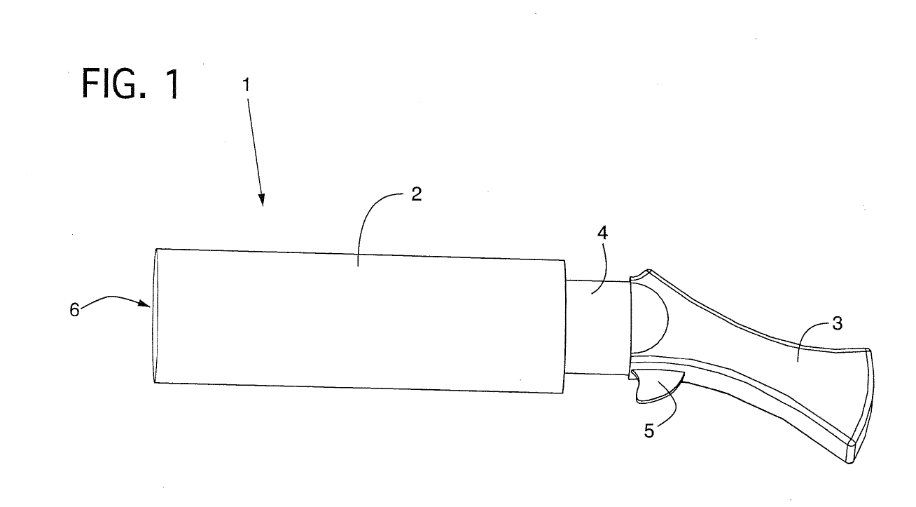

FIG. 1 shows a three-dimensional view of a fire extinguishing device according to an embodiment of the invention;

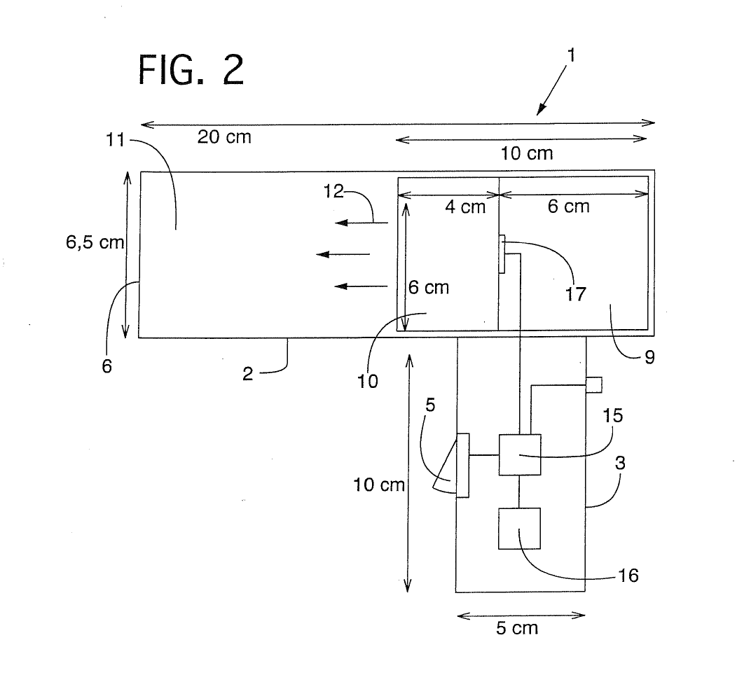

FIG. 2 shows a schematic cross-section of a fire extinguisher according to a second embodiment;

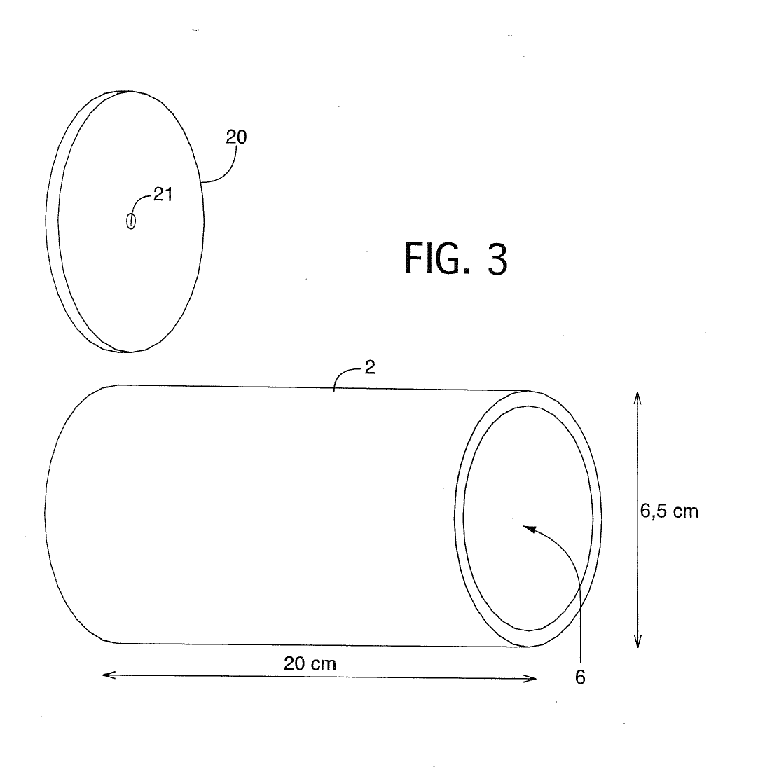

FIG. 3 shows the protective casing of FIG. 2 in more detail;

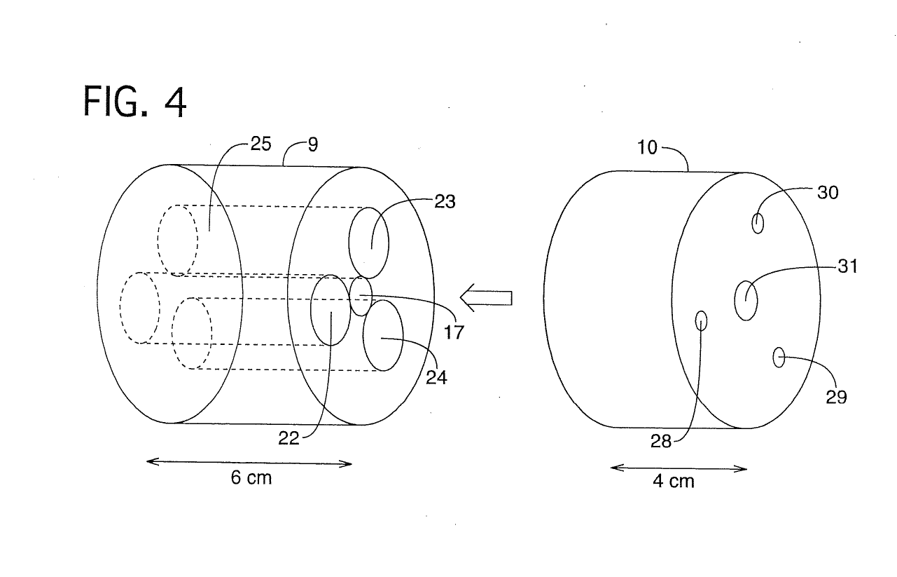

FIG. 4 shows a schematic three-dimensional representation of the cartridge holder and the combustion chamber;

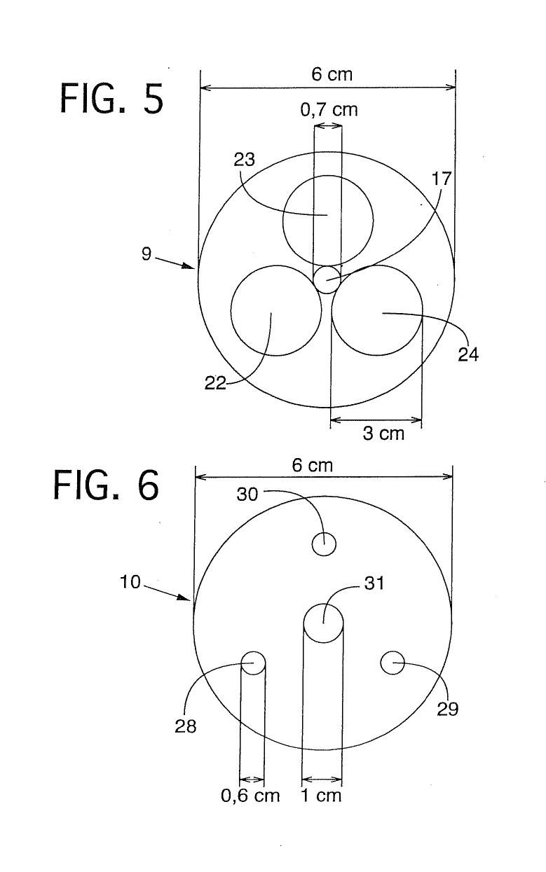

FIG. 5 shows a schematic front view of the cartridge holder;

FIG. 6 shows a schematic front view of the combustion chamber in which the openings can be seen;

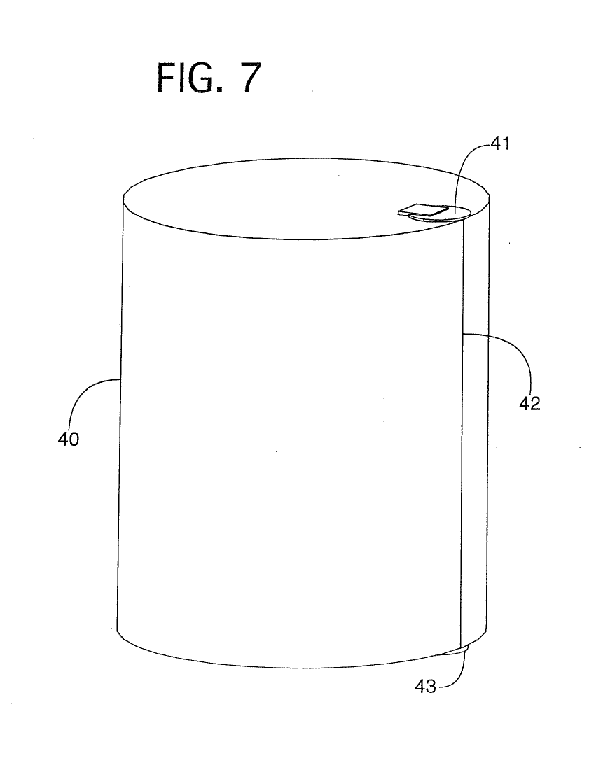

FIG. 7 shows an extinguishing cartridge as can be used in the fire extinguisher;

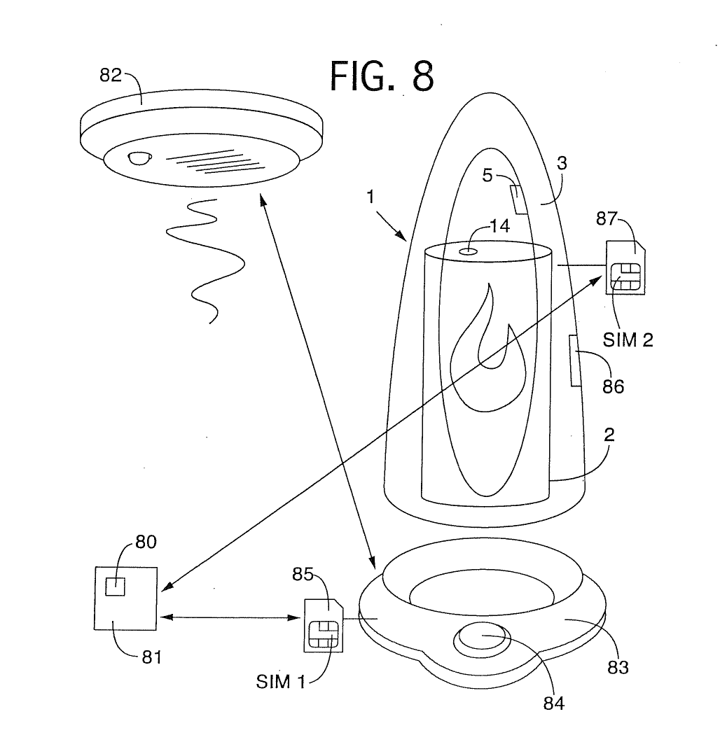

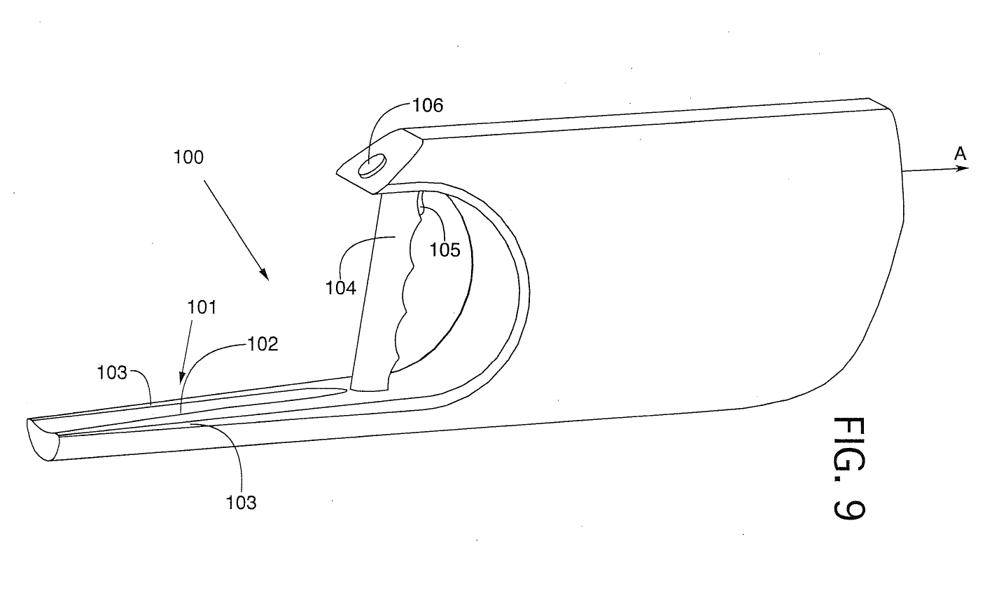

FIG. 8 shows schematically a part of a fire management system according to an embodiment of the invention;

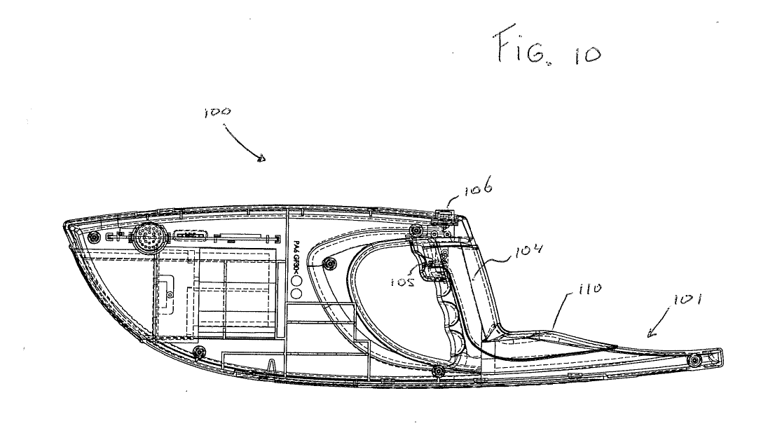

FIG. 9 shows a perspective view of a further preferred embodiment;

FIG. 10 shows a cut-away side view of a further embodiment.

FIG. 1 shows a three-dimensional view of a fire extinguishing device 1 according to an embodiment of the invention. Fire extinguishing device 1, referred to hereinbelow as fire extinguisher 1, comprises a protective casing 2 and a handle 3. In this embodiment handle 3 is connected to protective casing 2 via a cylindrical coupling piece 4. FIG. 1 also shows that there is an activating switch 5 on handle 3. Protective casing 2 has an opening 6 and comprises a cartridge holder (not shown) for holding extinguishing agent cartridges. This will be discussed in more detail hereinbelow.

If a user now detects a fire, he/she can use fire extinguisher 1 to extinguish a fire. He/she can then grasp fire extinguisher 1 by handle 3 and aim fire extinguisher 1 at the source of the fire. By pressing activating switch 5 the fire extinguisher 1 can then be activated, wherein extinguishing agent comes out of opening 6 of protective casing 2.

FIG. 2 shows a schematic cross-section of a fire extinguisher 1 according to a second embodiment, wherein handle 3 is oriented substantially perpendicularly of a main axis of fire extinguisher 1. This results in a fire extinguisher which can be handled as a pistol, wherein the user does not have to rotate the wrist. Coupling piece 4 is not present in this embodiment. FIG. 2 shows that two compartments are present in protective casing 2. One of the compartments is a cartridge holder 9 which is adapted to hold one or more extinguishing agent cartridges (not visible). The other compartment is a combustion chamber 10. The two said compartments fill only part of protective casing 2. The remaining part functions as barrel of fire extinguisher 1. The opening of the barrel is defined by opening 6 of protective casing 2. Typical values for the dimensions of the components of fire extinguisher 1 are indicated in FIG. 2.

FIG. 2 also shows activating switch 5 and a battery 16. This switch 5 is connected to circuit 15 for activating an ignition member 17. When the switch is pressed in, an electric current is conducted from battery 16 to ignition member 17 using circuit 15. Instead of a battery it is possible to use an accumulator which can be charged via an external connection. In order to indicate that battery/accumulator 16 is not yet empty an indicator 14 is present, such as a LED lamp, which indicates when the battery must be replaced or when the accumulator must be recharged. Instead of an LED lamp a small screen can also be present, on which the status of battery 16 is displayed. Ignition member 17 can for instance be a pyrothermal element which is heated by the current received from circuit 15.

Ignition member 17 is arranged in or close to cartridge holder 9. Extinguishing agent cartridges comprising an extinguishing agent which can be activated by heating are inserted into cartridge holder 9. This extinguishing agent preferably comprises potassium carbonate, ammonium hydrogen carbonate and/or potassium nitrate.

Cartridge holder 9 is adapted such that the inserted cartridges make contact with the ignition member. Activation of the extinguishing agent creates an aerosol in combustion chamber 10. Combustion chamber 10 comprises a number of openings in the direction of barrel 11. These openings are so small that a pressure is built up in combustion chamber 10. The aerosol hereby leaves combustion chamber 10 under increased pressure, this being indicated with arrows 12 in FIG. 2. The aerosol then leaves fire extinguisher 1 via barrel 11. Barrel 11 provides for a directed plume of the aerosol. The user can hereby aim properly at the source of the fire. By using suitable cartridges it is possible to create an aerosol plume with dimensions of between 2 and 5 metres for 90 seconds with the fire extinguisher. It has been found that the plume here has a sufficient density to extinguish a source of fire within the stated time period. It will be apparent to the skilled person that not all fires can be extinguished with the fire extinguisher according to the invention. Nor is this the object of the invention. The object of this fire extinguisher is to effectively extinguish a starting fire with a fire extinguisher which is relatively light and therefore easy to handle.

FIG. 3 shows protective casing 2 of FIG. 2 in more detail. Protective casing 2 can optionally be given a multi-walled form so that the outer wall of casing 2 does not become too hot during ignition of the extinguishing agent. Protective wall 2 is preferably manufactured from a light material such as plastic or aluminium. Other materials known to the skilled person can also be envisaged. At one of the outer ends of casing 2 the casing is closed using a disc 20. Disc 20 can comprise a hole 21 for attaching the handle to casing 2 or for mounting cartridge holder 9 in casing 2. Disc 20 can be welded or otherwise fixed onto casing 2.

According to an embodiment two compartments are placed in protective casing 2. These are cartridge holder 9 and combustion chamber 10 as shown schematically in a three-dimensional view in FIG. 4. In this embodiment cartridge holder 9 comprises three openings 22,23,24, which lead to cavities 25. The extinguishing agent cartridges can be placed in cavities 25. Cavities 25 are of cylindrical form here, but may also take a different form. Cavities 25 have only a single opening, although it is possible to envisage them having an opening on both sides so that a cartridge can be inserted on an infeed side. This infeed side is then closed, for instance by a cover. Cavities 25 preferably have the same shape as the extinguishing agent cartridges, which will be discussed in more detail hereinbelow. An activating member 17, such as a pyrothermal element 17, is arranged between openings 22,23,24. Pyrothermal element 17 comes into contact with the cartridges in a manner such that, when element 17 is heated, the heat is transferred to the cartridges.

Combustion chamber 10 is wholly open on the side directed toward cartridge container 9 and has on the other side a number of openings 28,29,30,31. In this embodiment a central opening 31 is present which is larger than openings 20,29,30.

Cartridge holder 9 and combustion chamber 10 can be coupled to each other by means of a screw connection, this being indicated with the thick arrow. Other types of connection can be envisaged.

FIG. 5 shows a schematic front view of cartridge holder 9, wherein openings 22,23,24 can be seen. Openings 22,23,24 are arranged round pyrothermal ignition element such that, when extinguishing agent cartridges are placed through the openings, they come into contact with the ignition element. Ignition element 17 is connected via for instance an electrical connection to circuit 15 shown in FIG. 2.

FIG. 6 shows a schematic front view of combustion chamber 10, wherein openings 28,29,30 can be seen. Openings 28,29,30 are arranged around central opening 31. The number of openings depends on the necessary pressure that must be developed. The pressure is of course also determined by the size of the openings. Typical values for the size of openings 28,29,30 are indicated in FIG. 6. An opening 28,29,30 is preferably placed for each cartridge.

In an embodiment the extinguisher 1 is embodied with an extending barrel. The user can here extend the barrel for use and shorten it again when fire extinguisher 1 is not required. The shortened extinguisher has a limited length and can be easily transported and/or stored. In a further embodiment handle 4 is removably attached to protective casing 2. It is hereby possible to supply the fire extinguisher with a separately obtainable handle which meets the requirements of the user. It may for instance be that a person in a wheelchair requires a different handle than someone who can walk.

FIG. 7 shows an extinguishing cartridge 40 as can be used in fire extinguisher 1. In this special embodiment the cartridge itself comprises a thermal activating module 41 which can be activated electrically via an electrical connection 42. Electrical connection 42 is connected to a contact surface 43. When cartridge 40 is inserted into a cartridge holder of fire extinguisher 1, contact surface 43 will come into contact with an activating point in fire extinguisher 1 which is adapted especially for this purpose and which is connected to circuit 15. In this embodiment the cartridge holder itself does not therefore require an ignition element 17, and the activating point in the cartridge holder functions as the activating member.

FIG. 8 shows schematically a part of a fire management system according to an embodiment of the invention. The fire management system comprises a device for extinguishing a fire, fire extinguisher 1, and a central processing unit 80 for processing data. Processing unit 80 is for instance a computer situated in an emergency centre 81. The fire management system further comprises a number of detectors 82 adapted to detect fire and/or smoke. A docking station 83 is further present for placing of fire extinguisher 1 therein. Docking station 83 is adapted to charge the fire extinguisher in a manner known to the skilled person. Once fire extinguisher 1 is charged, indicator 14 lights up and/or changes colour. Docking station 83 further comprises a button 84 which can be pressed by a user, for instance to cancel a fire alarm if necessary. Docking station 83 is adapted to communicate, optionally wirelessly, with emergency centre 81.

In the embodiment shown in FIG. 8 fire extinguisher 1 has a handle 3 which encloses protective casing 2. Handle 3 is adapted to receive protective casing 2, this such that protective casing 2 with the cartridge holder therein can be replaced. Activating switch 5 is present in the upper part of handle 3, see FIG. 8.

When a fire breaks out, smoke detector 82 will now detect smoke and/or an increased temperature, and smoke detector 82 will generate a visual and/or an audible signal. In this embodiment the smoke detector will moreover also communicate with docking station 83 so that this latter produces a visual and/or an audible signal. A person present can hereby easily trace fire extinguisher 1. It is also possible to envisage fire extinguisher 1 itself having the communication functions of docking station 83, so that docking station 83 is not necessary.

After the docking station has received an alarm from smoke detector 82, docking station 83 sends a message to emergency centre 81 using for instance SIM card 85. As stated, the user can cancel the alarm by pressing button 84.

The user now localizes fire extinguisher 1 and starts the extinguishing operation. It is possible to communicate with emergency centre 81 using fire extinguisher 1. For this purpose fire extinguisher 1 comprises a loudspeaker and communication means, not shown, with a SIM card 87 for optional use. By means of the SIM card contact can be maintained between the user and the control room of emergency centre 81. If the user indicates that he/she has the fire under control, the control room does not have to alert the fire brigade. This thus reduces the number of times the fire brigade turns out unnecessarily.

In an embodiment of the fire management system a database system is present which is adapted to store and manage data relating to the degree of self-sufficiency of a resident of a building. The control room can hereby be quickly informed of additional hazards to which a person in need of assistance is exposed during a fire. Before a connection is made between the control room and the user of the fire extinguisher, control room staff are thus aware of the self-sufficiency of the person to whom they are speaking. Valuable time is hereby saved since control room staff can ask focussed questions.

In an embodiment fire extinguisher 1 comprises a positioning system adapted, just as a GPS system, to determine the location of fire extinguisher 1. This position can be communicated to emergency centre 81 and/or the fire brigade. Without the user him/herself thus communicating with emergency centre 81 the centre is thus nevertheless aware of the exact location of the fire, or at least aware of the exact location of fire extinguisher 1.

FIG. 9 shows a perspective view of a further preferred embodiment of a fire extinguisher 100 according to the present invention. This fire extinguisher 100 of highly ergonomic form has a technical operation as described in one or more of the foregoing preferred embodiments. Fire extinguisher 100 has an extinguishing agent outlet direction in the direction of arrow A. This direction of arrow A is substantially in the line of the arm of the user holding the device.

Fire extinguisher 100 is a light device unprecedented for a fire extinguisher, and can be handled by the user in very simple manner. The user holds the device by handle 104, wherein the index finger is able to operate actuating button 105. The thumb is also able to operate safety button 106. The fire extinguisher will be activated when these two buttons are operated simultaneously. The communication means will herein also be activated, and the location determination will be performed. Depending on the power source, the location determination can also be carried out continuously or at set times prior to use.

In order to improve handling of the device an arm support 101 is arranged along one side of handle 104. This arm support 101 has a curved wall, with a base 102 and support elements 103 curving on either side away from base 102. The arm support is designed such that the arm can be placed in the curvature thereof for a stable ‘placing’ of the arm. The arm support makes it easier for the user to determine or maintain the spraying direction during spraying of the extinguishing agent from fire extinguisher 100.

In an embodiment, see FIG. 10, the arm support comprises an elevation 110, whereby a support surface of the arm support follows the shape of the wrist of a user. The arm support, or wrist support, hereby fits closely on and provides optimal contact with the wrist. This increases the comfort and control for the user.

The present invention is described in the foregoing on the basis of several preferred embodiments. Different aspects of different embodiments are deemed described in combination thereof, wherein all combinations which can be made by a skilled person on the basis of this document should be included. These preferred embodiments are not limitative for the scope of protection of this text. The rights sought are defined in the appended claims.

1. Device (1) for extinguishing a fire which is suitable for carrying and handling by persons, comprising:
a pressureless container (9) for placing of an extinguishing agent in solid form;
an ignition member (17) for electrical or thermal ignition of the extinguishing agent for the purpose of forming aerosol during extinguishing operations;
a discharge member (11) for discharge of the aerosol in a directed jet or plume;
a handling member (3) for handling of the device by a user; and
a communication member for remote communication.

2. Device as claimed in claim 1, comprising location-determining means for determining the geographic location of the device in automated manner.

3. Device as claimed in claim 2, wherein the location-determining means comprise GPS, AGPS and/or location-determining means based on mobile telephony standards.

4. Device as claimed in claim 1, wherein the communication member comprises voice communication means.

5. Device as claimed in claim 1, wherein the communication member is adapted for two-way communication.

6. Device as claimed in claim 1, wherein the device is adapted to send a message to a fire management system as soon as the ignition member is activated.

7. Device as claimed in claim 1, wherein the device comprises a connector for placing in a docking station for the purpose of charging a battery in the device.

8. Device as claimed in claim 1, wherein the extinguishing agent comprises potassium carbonate, ammonium hydrogen carbonate and/or potassium nitrate.

9. Device as claimed in claim 1, wherein the device comprises a protective casing (2), a part of which functions as discharge member and in which the pressureless container is arranged, optionally in removable manner.

10. Device as claimed in claim 9, wherein the protective casing comprises a plastic.

11. Device as claimed in claim 1, comprising an activating switch arranged in or on the handle and, at least during use, electronically connected to the ignition member, wherein the ignition member is activated by switching the activating switch.

12. Device as claimed in claim 1, wherein the pressureless container comprises a cartridge holder adapted for the placing of one or more extinguishing agent cartridges, wherein the number lies between 1-6 and preferably equals 3.

13. Device as claimed in claim 1, wherein the device comprises a chamber for receiving aerosol from the pressureless container, wherein the chamber comprises a plurality of openings in an outlet wall for passage of the aerosol.

14. Device (1) for extinguishing a fire which is suitable for carrying and handling by persons, comprising:
a pressureless container (9) for placing of an extinguishing agent in solid form;
an ignition member (17) for electrical or thermal ignition of the extinguishing agent for the purpose of forming aerosol during extinguishing operations;
a discharge member (11) for discharge of the aerosol in a directed jet or plume;
a handling member (3) for handling of the device by a user; and
an arm support member for supporting the arm during an extinguishing operation, wherein the arm support member extends substantially in line with the direction in which the extinguishing agent is discharged.

15. Device as claimed in claim 14, wherein the arm support comprises a support surface which substantially follows the shape of the wrist of a user.

16. Cartridge for a device as claimed in claim 1, wherein the cartridge comprises an extinguishing agent for forming aerosols.

17. Cartridge as claimed in claim 16, wherein the cartridge is of cylindrical form, and is substantially enclosed by a packaging.

18. Cartridge as claimed in claim 16, wherein the cartridge comprises a through-hole.

19. Cartridge as claimed in claim 16, wherein the cartridge comprises a thermal activating module which is adapted to generate a predetermined temperature using an electric current and to thus activate the extinguishing agent.

20. Fire management system for registering a fire, comprising:
a device as claimed in claim 1;
a central communication unit for providing communication with the devices.

21. Fire management system as claimed in claim 20, comprising a number of detectors adapted to detect fire and/or smoke.

22. Fire management system as claimed in claim 20, comprising at least a docking station for placing of the device therein.

23. Fire management system as claimed in claim 22, wherein the docking station is adapted to communicate, optionally wirelessly, with an emergency centre.

24. Fire management system as claimed in claim 20, comprising at least a smoke detector adapted to generate a signal, such as a sound signal or an electronic signal.

25. Fire management system as claimed in claim 24, wherein the smoke detector is adapted to communicate a message, optionally wirelessly, to the device and/or the docking station.

26. Fire management system as claimed in claim 20, comprising a database system adapted to store and manage the identity and data relating to the degree of self-sufficiency of a resident of a building.

27. Fire management system as claimed in claim 26, wherein the database system is adapted to store and manage an action to be taken in the case of a calamity.
